(19) United States
(12) Patent Application Publication
(10) Pub. No.: US 2011/0115754 A1
(43) Pub. Date: May 19, 2011

(54) Systems and Methods For A Friction Rotary Device For Haptic Feedback

(75) Inventor: Juan Manuel Cruz-Hernandez, Montreal (CA)

(73) Assignee: Immersion Corporation, San Jose, CA (US)

(21) Appl. No.: 12/947,532

(22) Filed: Nov. 16, 2010

Related U.S. Application Data
(60) Provisional application No. 61/262,038, filed on Nov. 17, 2009.

(51) Int. Cl. G06F 3/033; H04B 3/36

(52) U.S. Cl. 345/184; 340/407.1

(57) ABSTRACT

Systems and methods for a friction rotary device for haptic feedback are disclosed. For example, one disclosed system includes: a haptic device including: a passive actuator including: a rotatable plate; a fixed plate configured to apply friction to the rotatable plate; a piezoelectric material mounted to one of the fixed plate or the rotatable plate, the piezoelectric material configured to receive a first haptic signal and vibrate; and a rotatable object configured to be connected to the rotatable plate.

### CROSS REFERENCE TO RELATED APPLICATIONS

This application claims priority to U.S. Provisional Application No. 61/262,038, entitled Friction Rotary Device for Haptic Feedback, filed on Nov. 17, 2009, the entirety of which is hereby incorporated by reference.

### FIELD OF THE INVENTION

The present disclosure relates generally to haptic feedback devices and in particular to an improved rotary device for haptic feedback.

### BACKGROUND

Haptic feedback devices are used in many industries to simulate real life situations and provide direct feedback to users. A rotary haptic feedback device is a particular type of haptic feedback device that provides haptic feedback to devices that rotate such as a joystick or a knob.

These rotary haptic feedback devices are either active (e.g., a direct current (DC) motor controls rotation) or passive (e.g., a brake controls rotation using friction). Passive rotary haptic feedback devices provide resistive forces against an external rotation. Users feel the forces when rotating an object connected to the passive rotary haptic feedback device.

Passive rotary haptic feedback devices include a surface that rotates relative to another surface—the other surface may be part of the passive device or may be a surface of an object that is coupled to the passive device. It is advantageous to have the two surfaces as close together as possible so that stronger haptic forces can be generated. However, when the surfaces are positioned too close together, the static friction between the surfaces degrades the quality of feedback because the device does not move smoothly. Typically, a large initial force must be applied by the user to overcome this static or initial friction.

### SUMMARY

Embodiments of the present invention provide systems and methods for a friction rotary device for haptic feedback. For example, in one embodiment, a system for a friction rotary device for haptic feedback comprises: a haptic device comprising: a passive actuator comprising: a rotatable plate; a fixed plate configured to apply friction to the rotatable plate; a piezoelectric material mounted to one of the fixed plate or the rotatable plate, the piezoelectric material configured to receive a first haptic signal and vibrate; and a rotatable object configured to be connected to the rotatable plate.

This illustrative embodiment is mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIGS. 1A and 1B are block diagrams of systems for haptic systems having passive actuators according to embodiments of the present invention.

FIG. 2A is a schematic view of a rotary resistive device according to the prior art.

FIG. 2B is a schematic view of a passive actuator according to an embodiment of the present invention.

FIG. 3 is an illustration of a method for reducing friction in a haptic feedback device in accordance with an embodiment of the present invention.

FIG. 4 is a perspective view of a system that includes the passive actuator of FIG. 2B in accordance with an embodiment of the present invention.

FIGS. 5A and 5B are perspective views of a system that includes the passive actuator of FIG. 2B in accordance with an embodiment of the present invention.

FIG. 6 is a perspective view of a system that includes the passive actuator of FIG. 2B in accordance with an embodiment of the present invention.

FIG. 7 is a perspective view of a system that includes the passive actuator of FIG. 2B in accordance with an embodiment of the present invention.

FIG. 8 is a perspective view of a system that includes the passive actuator of FIG. 2B in accordance with an embodiment of the present invention.

FIG. 9 is a perspective view of a system that includes the passive actuator of FIG. 2B in accordance with an embodiment of the present invention.

### DETAILED DESCRIPTION

Embodiments of systems and methods for systems and methods for a friction device for rotary haptic feedback are described herein. Haptic feedback systems that include the passive rotary haptic feedback device and methods of using the passive rotary haptic feedback device are also described.

### Illustrative Embodiment of a System for a Friction Rotary Device for Haptic Feedback

One illustrative embodiment of the present invention comprises a rotary control knob, which controls one or more functions in an electronic device. For example, a volume knob, which, when rotated, controls the volume output by a stereo amplifier. In other embodiments, different devices may be controlled by the illustrative control device.

The illustrative control device comprises a passive actuator, a knob connected to the passive actuator by a drive shaft, a sensor configured to detect motion of the knob, and a microcontroller comprising a processor and a memory. In the illustrative device, the passive actuator comprises a fixed plate, which applies friction to a rotatable plate connected to the knob. The user feels this friction as a force restricting the rotation of the knob. Thus, when a user turns the knob, the user feels resistance against the knob's rotation. In the illustrative device, the passive actuator further comprises a piezoelectric material communicatively connected to the microcontroller. In the illustrative device, the piezoelectric material is mounted between the fixed plate and the rotatable plate. The piezoelectric material is configured to vibrate at an ultrasonic frequency when actuated by a first haptic signal received from the microcontroller. This ultrasonic vibration is configured to create a film of air between the fixed plate and the rotatable plate in the passive actuator, and thus reduce or eliminate the friction between the fixed plate and the rotatable plate. Therefore, when the piezoelectric actuator is vibrating, the user feels less resistance when manipulating the control knob.

In the illustrative device, the sensor is configured to detect motion of the knob. The sensor then transmits a sensor signal comprising information corresponding to this motion to the microcontroller. The sensor signal may comprise, for example, information related to the knob's acceleration, angular velocity, or some other information. Based on this sensor signal, the microcontroller is configured to adjust the amplitude or frequency of the first haptic signal. These adjustments change the frequency or intensity of the vibrations of the piezoelectric material, and thereby change the resistance force output by the passive actuator. These changes in resistance simulate various rotary haptic effects. For example, when the sensor transmits a sensor signal indicating that the user has rotated the knob by ten degrees, the microcontroller may be configured to adjust the frequency or voltage of the first haptic signal such that the resistance output by the passive actuator is increased. This effect may simulate a detent, or notch, in the rotation of the knob. This effect will give the user the sensation that the knob has reached or crossed a barrier, providing the user with an indication of the distance that the knob has moved.

In other embodiments, the microcontroller may also be configured to transmit a first haptic signal to the piezoelectric material to provide other haptic effects, such as barriers, hills, compound effects, or constant forces. Detent effects may be used to mark fine or course increments or selections (e.g., notches). Barriers may restrict or prevent the user's motion and may be useful for indicating, for example, first and last items, minimums and maximums or the edges of an area and give the sensation of hitting a hard stop. Hill effects are often used for menu wraparounds, indicating a return from a sub-menu, signaling the crossing of the boundary to give the sensation of a plateau style of wide detent. Compound effects include two or more effects, such as small detents with a deeper center detent and barriers on both sides for balance control. Constant force can be used to simulate dynamics such as gravity, friction or momentum. In some embodiments, various tactile parameters, such as the shape, width, amplitude and number of detents, the type and strength of bounding conditions, can be modified to provide a particular haptic feedback feeling to the user.

This illustrative example is given to introduce the reader to the general subject matter discussed herein. The invention is not limited to this example. The following sections describe various additional non-limiting embodiments and examples of systems and methods for a friction rotary device for haptic feedback.

### Illustrative Systems for a Friction Rotary Device for Haptic Feedback

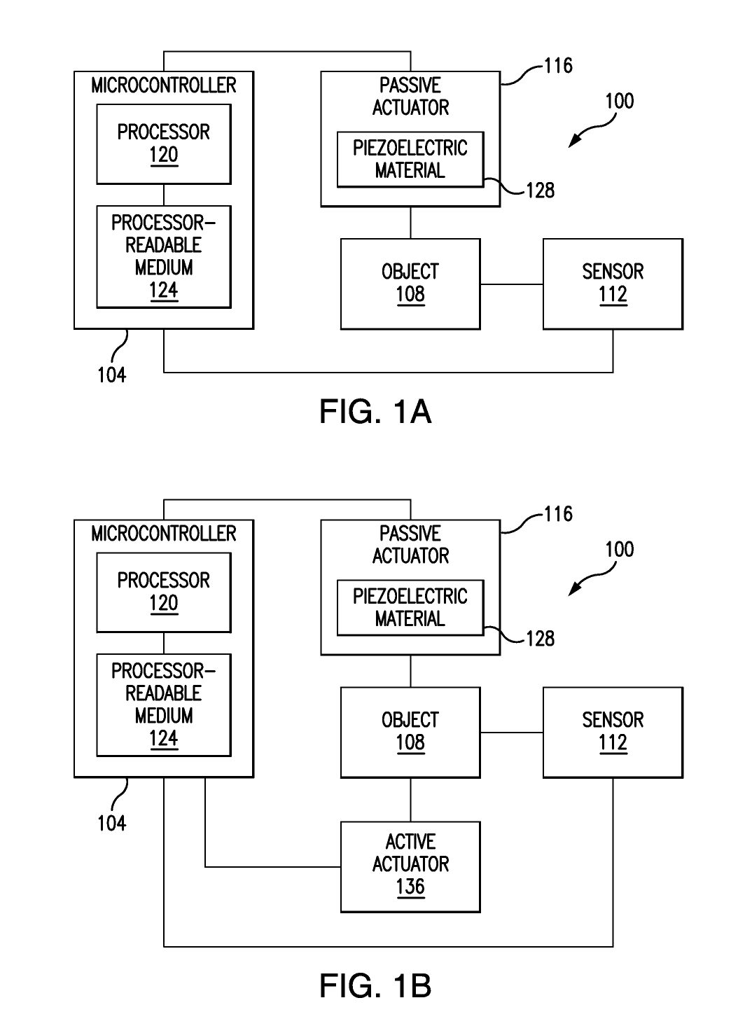

Referring now the drawings in which like numerals indicate like elements throughout the several figures. FIG. 1A is an illustration of a haptic feedback system 100, which includes a microcontroller 104, an object 108, a sensor 112 and a passive actuator 116. The passive actuator 116 includes a piezoelectric material 128. The microcontroller 104 includes a processor 120 and a processor-readable storage medium 124.

The processor 120 is configured to execute one or more sets of instructions embodying methodologies or functions described hereinafter. Processor 120 may comprise a microprocessor, a digital signal processor (DSP), an application-specific integrated circuit (ASIC), one or more field programmable gate arrays (FPGAs), or state machines. Processor 120 may further comprise a programmable electronic device such as a programmable logic controller (PLC), a programmable interrupt controller (PIC), a programmable logic device (PLD), a programmable read-only memory (PROM), an electronically programmable read-only memory (EPROM or EEPROM), or other similar devices. The processor 120 and the processing described may be in one or more structures or may be dispersed throughout one or more structures.

Processor-readable medium 124 comprises a computer-readable medium that stores instructions, which when executed by processor 120, cause processor 120 to perform various steps, such as those described herein. Embodiments of computer-readable media may comprise, but are not limited to, an electronic, optical, magnetic, or other storage or transmission devices capable of providing processor 120 with computer-readable instructions. Other examples of media comprise, but are not limited to, a solid-state hard drive, a floppy disk, CD-ROM, magnetic disk, memory chip, ROM, RAM, ASIC, configured processor, all optical media, all magnetic tape or other magnetic media, or any other medium from which a computer processor can read. In addition, various other devices may include computer-readable media such as a router, private or public network, or other transmission devices.

In some embodiments, microcontroller 124 may be coupled to a host computer via an interface (not shown in FIG. 1A or 1B). In such an embodiment, the host computer may run a program with which the user interacts via manipulation of object 108. For example, the application may display a graphical user interface, and manipulation of the object 108 may modify objects displayed in a graphical user. In this example, the movement detected by the sensor 112 is used by the host computer to detect and display the movements of the graphical user interface object. In some embodiments, the host computer may also calculate haptic feedback to provide to the user based on these interactions. In some embodiments, the host computer may also perform force calculations, event handling, or other communications. Further, in some embodiments, microcontroller 104 may be located on a separate host computer configured to receive signals from sensor 112 and transmit haptic signals to passive actuator 116 and active actuator 136.

The object 108 is rotatable relative to the passive actuator 116 by a user of the haptic feedback system 100. Object 108 is connected to the passive actuator 128 by a driveshaft, which enables the user to feel haptic feedback in the form of resistive force applied to prevent rotation of object 108. In some embodiments, object 108 may be coupled to two or more passive actuators 116 that may individually or jointly provide haptic feedback to the user. In some embodiments, the object 108 may comprise a manipulandum, for example, a knob, a scroll wheel, a lever, a joystick, or a T-handle. In other embodiments, the object 108 may comprise another moveable component, for example a drive shaft or yoke connected to a gimbal mechanism.

In some embodiments, passive actuator 116 comprises a fixed plate, which is positioned such that it applies friction to a rotatable plate. The rotatable plate is connected by a driveshaft to object 108, such that the rotatable plate and object 108 rotate together. Therefore, the friction between the fixed plate and the rotatable plate applies a resistive force to the driveshaft, preventing or slowing the rotation of the object 108.

Actuator 116 further comprises a piezoelectric material 128, which in some embodiments, is mounted between the fixed plate and the rotatable plate. In other embodiments, the piezoelectric material 128 may be mounted to the fixed plate, the rotatable plate, or some other location within the passive actuator. The piezoelectric material 128 is configured to be driven in the ultrasonic frequency range (e.g., greater than about 20 kHz), by a first haptic signal received from microcontroller 104. The first haptic signal causes piezoelectric material 128 to vibrate and squeeze a film of air between the fixed plate and the rotatable plate to reduce the friction between the fixed plate and the rotatable plate. In some embodiments, microcontroller 104, may adjust the voltage or frequency of the first haptic signal to change the frequency or intensity of vibration of the piezoelectric material and therefore change the friction between the fixed plate and the rotatable plate. The user feels this change in friction as a change in the force required to rotate object 108. This change in force may be used to simulate various effects, for example, detents, barriers, hills, compound effects, or constant forces.

Piezoelectric materials that may be used in the passive actuator 116 include both monolithic and composite piezoelectric actuators. These may be composed of for example, piezoceramics, polymers that exhibit piezoelectric properties and other piezoelectric materials, for example barium titanate (BaTiO₃), lead titanate (PbTiO₃), lead zirconate titanate (Pb[ZrₓTi₁₋ₓ]O₃, 0≦x≦1, also referred to as PZT), potassium niobate (KNbO₃), lithium niobate (LiNbO₃), lithium tantalate (LiTaO₃), sodium tungstate (Na₂WO₃), Ba₂NaNb₅O₅, Pb₂KNb₅O₁₅, and sodium potassium niobate (KNN), bismuth ferrite (BiFeO₃). Polyvinylidene fluoride (PVDF) is a polymer that may be used. Further, the piezoelectric material may be quartz or a quartz-like material as known to those of ordinary skill in the art.

The sensor 112 is configured to detect the position or rotation of the object 108. The sensor 112 is in communication with the microcontroller 104, and is configured to transmit a sensor signal to the microcontroller 104 that indicates the position, rotation, acceleration, or velocity of the object 108. In some embodiments, sensor 112 may comprise an optical encoder, a magnetic sensor, an accelerometer, or some other type of sensor configured to detect position or rotation. In some embodiments, sensor 112 is configured to transmit a sensor signal to the device controlled by object 108. For example, in one embodiment, object 108 is a volume knob on a stereo, sensor 112 may detect the movement of the volume knob and transmit this information to microcontroller 108, which controls the volume output by the stereo. In other embodiments, the device may comprise a separate mechanical sensor that is unrelated to haptic functionality, and directly interacts with the device controlled by object 108. For example, in one embodiment, object 108 is a volume knob on a stereo. In such an embodiment, object 108 may be connected to a variac, variable resistor, op-amp circuit, or some other component, which controls the volume output of the amplifier. In some embodiments, this connection may be mechanical or electrical.

In some embodiments, microcontroller 104 is configured to modify the first haptic signal based in part on the sensor signal received from sensor 112. For example, in some embodiments, as the user rotates the object 108, the sensor 112 detects the position or rotation of the object 108 and transmits a corresponding signal to the microcontroller 104. The microcontroller 104 then transmits a signal to the passive actuator 116 to adjust the frequency, voltage, or current of the signal applied to the piezoelectric material 128. This adjustment of the frequency, voltage, or current of the signal modifies the vibration of the piezoelectric material 128, and therefore the force applied to object 108 by passive actuator 116. This change in force can be used to output a desired haptic feedback to the user. For example, to indicate the object 108 has passed over a notch, microcontroller 104 may reduce or stop the signal to the piezoelectric material 128, thus increasing the resistance the user feels when moving object 108 over that location. This increased resistance may simulate the sensation that object 108 has passed over a virtual notch. Once the sensor detects that the object 108 has moved over the virtual notch, the microcontroller 104 may increase the haptic signal or transmit another haptic signal to piezoelectric material 128, thus causing the object 108 to rotate more easily.

In some embodiments, microcontroller 104 is configured to control a signal generator that generates the haptic signal. In other embodiments, microcontroller 104 is configured to output the first haptic signal. In such an embodiment, microcontroller 104 may drive an actuator, which outputs the haptic signal to the piezoelectric material 128.

FIG. 1B illustrates a haptic feedback system 100 that includes both the passive actuator 116 and an active actuator 136. Active actuator 136 is configured to receive a haptic signal from microcontroller 104 and generate a haptic effect corresponding to that haptic signal. Actuator 118 may be, for example, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA). In some embodiments, actuator 136 may comprise a plurality of actuators, for example an ERM and an LRA.

In some embodiments, passive actuator 116 and active actuator 136 may be used together to generate haptic effects. For example, in one embodiment, object 108 may comprise a knob. In such an embodiment, microcontroller 104 may be configured to transmit a haptic signal to passive actuator 116 configured to cause passive actuator 116 to generate a haptic effect simulating a notch at every ten degrees in the rotation of the knob. In such an embodiment, microcontroller 104 may be configured to output first haptic signal to passive actuator 116, which is configured to cause piezoelectric material 128 to output a ultrasonic vibration that causes the knob to rotate smoothly. Further, in such an embodiment, microcontroller 104 may be configured to cut the first haptic signal when microcontroller 104 receives a sensor signal from sensor 112 indicating that the knob has rotated by ten degrees. At this point, the user turning the knob, will feel additional resistance because the piezoelectric material is no longer vibrating. This additional resistance may simulate a notch in the rotation of the knob.

Further, in such an embodiment, the last thirty degrees of rotation of the knob may be a maximum power, or redline, area of rotation. Thus, to warn the user of the risk of overloading the system controlled by the knob, when microcontroller 104 receives a sensor signal from sensor 112 indicating that the knob is in its final thirty degrees of rotation, microcontroller 104, may transmit a second haptic signal to active actuator 136. In such an embodiment, the second haptic signal may be configured to cause active actuator 136 to output a haptic effect or to cause the passive actuator to increase resistance to rotation. Further, in such an embodiment, as the user rotates the knob further, microcontroller 104 may change amplitude or frequency characteristics of the second haptic signal, causing the haptic effect output by active actuator 136 to vary in intensity.

In another embodiment, active actuator 136 may be a DC motor that applies a return, or rotary, force to the knob. For example, in the embodiment described above, if the user leaves the knob in the final thirty degrees of rotation for longer than a predetermined period of time, microcontroller 104 may transmit a second haptic signal to active actuator 136, configured to cause active actuator 136 to rotate the knob a predetermined number of degrees. This function may be used, for example, as an automatic override, which moves the knob to a position that reduces the risk of overloading the system controlled by the knob.

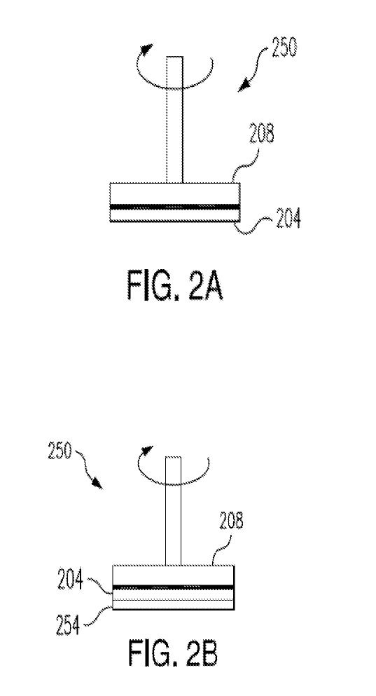

FIG. 2A illustrates a conventional rotary resistive device 200. As shown in FIG. 2A, in the conventional rotary resistive device 200, a first plate 204 and a second rotatable plate 208 are in a contacting relationship to generate friction. The friction generated by the rubbing of the plates 204 and 208 provides haptic feedback to the user. This device, however, has a significant initial or static friction because the plates 204 and 208 are in a contacting relationship. Accordingly, when the user turns rotatable plate 208, the user does not feel a smooth rotation, particularly during the initial motion as the user breaks the static friction between first plate 204 and rotatable plate 208.

FIG. 2B illustrates a rotary device 250 according one embodiment of the present invention. As shown in FIG. 2B, a piezoelectric material 254 is mounted to first plate 204. In such an embodiment, the first plate 204 may make contact with, and apply friction to the second rotatable plate 208. In other embodiments, piezoelectric material may be mounted between the first plate 204 and the second rotatable plate 208, such that piezoelectric material 254 applies friction to second rotatable plate 208. In still other embodiments, piezoelectric material 254 may be mounted to second rotatable plate 208. In one embodiment, the piezoelectric material 254 is a piezoceramic plate that is attached to the first plate 204. The piezoelectric material 254 is configured to be driven by a haptic signal at an ultrasonic frequency range. When piezoelectric material 254 vibrates at an ultrasonic frequency, it can reduce the friction between the plates 204 and 208. This drop in friction may alleviate manufacturing tolerances and may improve the quality of the haptic feedback. Thus, when the user rotates rotatable plate 208 in FIG. 2B, the rotation may be smoother and require less force.

In the embodiments described with regards to FIGS. 2A and 2B above, the friction is modified by adjusting the voltage, current, or frequency of the signal applied to the piezoelectric material, which causes the piezoelectric material to vibrate at a greater or lesser magnitude. In addition, the friction may also or alternatively be modified by adjusting the distance between the plates 204 and 208 after the initial or static friction value has been adjusted.

### Illustrative Method for Reducing Friction in a Rotary Device

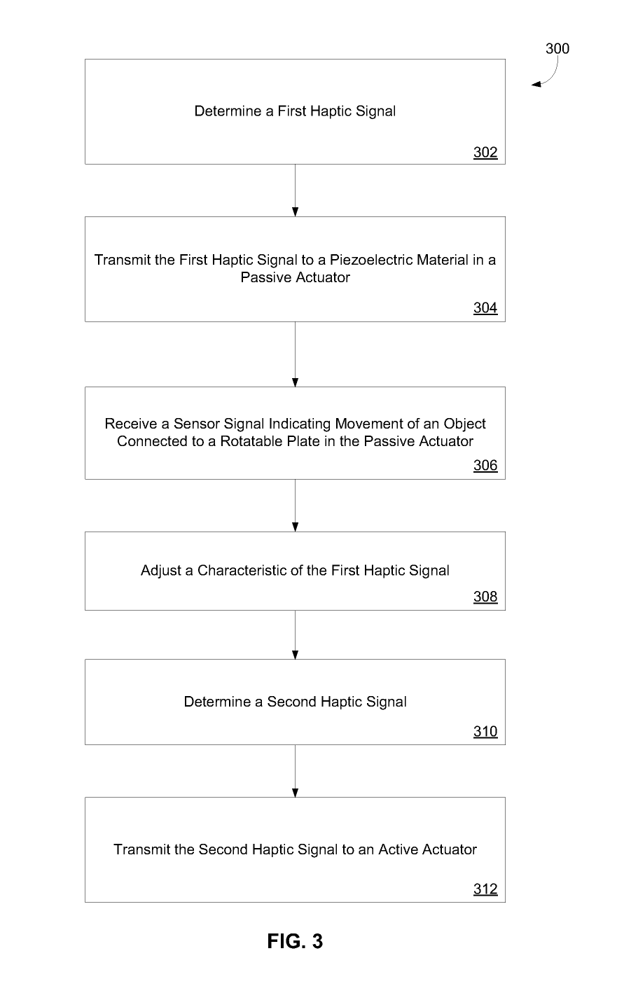

Referring now to FIG. 3, FIG. 3 is an illustration of a method 300 for reducing friction in a rotary device according to one embodiment of the present invention. In some embodiments processor executable program code comprising the steps of process 300 is stored on the processor readable medium 124 of the microcontroller 104 and executed by the processor 120. In other embodiments, processor executable program code comprising the steps of process 300 may be stored and executed by a host computer.

The process 300 begins at step 302 when microcontroller 104 determines a first haptic signal. The first haptic signal comprises an ultrasonic signal configured to drive piezoelectric material 128. In some embodiments, microcontroller 104 is configured to control a signal generator that generates the haptic signal. In other embodiments, microcontroller 104 is configured to output the first haptic signal. In such an embodiment, microcontroller 104 may drive an actuator, which outputs the haptic signal to the piezoelectric material 128. In some embodiments, microcontroller 104 may determine the first haptic signal based on a sensor signal received from sensor 112. For example, in some embodiments microcontroller 104 may determine the first haptic signal when it receives a sensor signal indicating that a user is manipulating object 108. In other embodiments, microcontroller 104 may determine the first haptic signal based on an application running on a host computer in connection with microcontroller 104, for example a control systems application. In other embodiments, microcontroller 104 may determine the first haptic signal based on some other condition, for example a change in time, temperature, or operating condition of a device controlled by object 108.

Next, at step 304, microcontroller 104 transmits the first haptic signal to a piezoelectric material 128 in a passive actuator. When active, piezoelectric material 128 is configured to vibrate at an ultrasonic frequency, and thereby create a thin film of air between a fixed plate and a rotatable plate in passive actuator 116, and thus reduce the friction in passive actuator 116. This reduces the force required to manipulate object 108, which is connected to rotatable plate.

The process 300 continues at step 306 when sensor 112 detects movement of an object 108 coupled to passive actuator 116, and transmits a sensor signal. In some embodiments, object 108 may comprise a manipulandum, for example, a knob, a scroll wheel, a lever, a joystick, or a T-handle. The sensor 112 is configured to detect the position or rotation of the object 108. In some embodiments, sensor 112 may comprise an optical encoder, a magnetic sensor, an accelerometer, or some other type of sensor configured to detect position or rotation. When sensor 112 detects motion of object 108, it transmits a sensor signal to microcontroller 104 comprising information associated with that movement. For example, the sensor signal may comprise information such as velocity, acceleration, or position change of object 108.

At step 308, the microcontroller 104 adjusts the first haptic signal. For example, microcontroller 104 may adjust the frequency or amplitude of the first haptic signal to adjust the resistance the user feels when manipulating object 108, and thereby simulate various rotary effects on object 108. For example, the force applied to object 108 may simulate a detent effect, which can be used to simulate fine or course increments or selections (e.g., notches). Another example effect is a barrier that restrict the user's motion and are useful for indicating, for example, first and last items, minimums and maximums or the edges of an area and give the sensation of hitting a hard stop. Other types of effects include hill effects, which are often used for menu wraparounds, indicating a return from a sub-menu, signaling the crossing of the boundary to give the sensation of a plateau style of wide detent. Compound effects include two or more effects, such as small detents with a deeper center detent and barriers on both sides for balance control. Constant force can be used to simulate dynamics such as gravity, friction or momentum. In some embodiments, various tactile parameters, such as the shape, width, amplitude and number of detents, the type and strength of bounding conditions, can be modified to provide a particular haptic feedback feeling to the user. These, and other effects, may be simulated by adjusting the frequency or amplitude of the first haptic signal driving piezoelectric material 128.

The process 300 continues at step 310 when microcontroller 104 determines a second haptic signal. The second haptic signal is configured to cause an active actuator 136 to output a haptic effect. In some embodiments, microcontroller 104 is configured to control a signal generator that generates the second haptic signal. In other embodiments, microcontroller 104 is configured to output the second haptic signal. In some embodiments, microcontroller 104 may determine the first haptic signal based on a sensor signal received from sensor 112. For example, in some embodiments microcontroller 104 may determine the second haptic signal when it receives a sensor signal indicating that a user is manipulating object 108. In other embodiments, microcontroller 104 may determine the first haptic signal based on an application running on a host computer in connection with microcontroller 104, for example a control systems application. In other embodiments, microcontroller 104 may determine the second haptic signal based on some other condition, for example a change in time, temperature, or operating condition of a device controlled by object 108.

Finally, at step 312, microcontroller 104 transmits the second haptic signal to an active actuator 136 configured to receive the second haptic signal and output a haptic effect. Active actuator 136 may be, for example, a piezoelectric actuator, an electric motor, an electro-magnetic actuator, a voice coil, a linear resonant actuator, a shape memory alloy, an electro-active polymer, a solenoid, an eccentric rotating mass motor (ERM), or a linear resonant actuator (LRA). The haptic effect may comprise one of several haptic effects known in the art, for example, vibrations, knocking, buzzing, jolting, or torquing the messaging device. In some embodiments, the second haptic signal is configured to cause active actuator 136 to output a vibration based haptic effect. In other embodiments, the second haptic signal is configured to cause active actuator 136 to provide a return force. For example, in some embodiments, the second haptic signal is configured to cause active actuator 136 to cause object 108 to rotate a predetermined number of degrees.

### Illustrations of Various Embodiments Using a Friction Device for Rotary Haptic Feedback

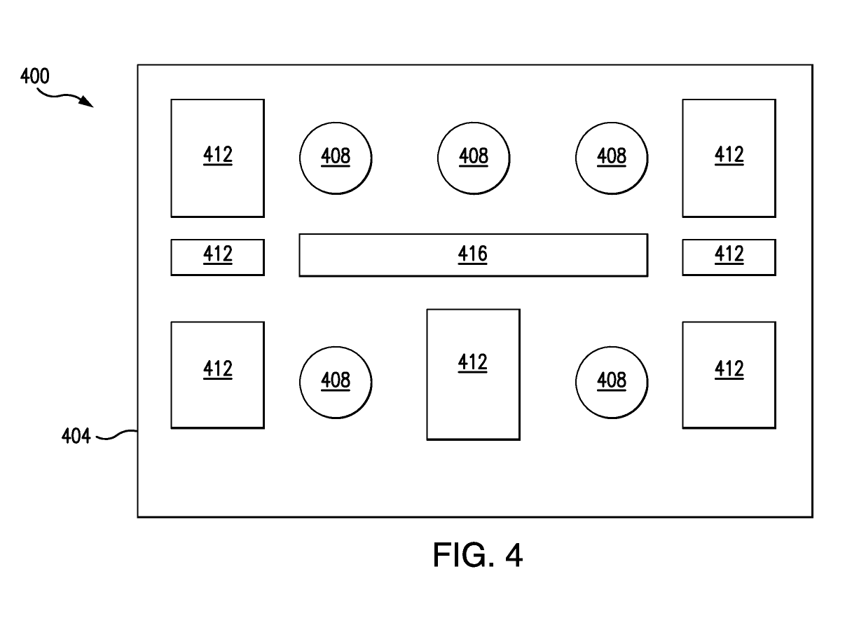

FIG. 4 is an illustration of one example of a haptic feedback system 400, which includes the passive actuator of FIG. 2B according to one embodiment of the present invention. In FIG. 4, a control panel 404 includes multiple knobs 408, multiple buttons 412, and a display 416. In other embodiments, control panel 404 may have a different configuration, for example different combinations of buttons, knobs, displays, and other types of user interfaces. In control panel 404, one or more of the knobs 408 include or are coupled to a passive actuator that includes piezoelectric material.

In the embodiment shown in FIG. 4, each of knobs 408 is connected to a passive actuator comprising a piezoelectric material (not shown in FIG. 4). When a microcontroller applies a voltage or current to the piezoelectric material, the force output by the passive actuator on knob 408 is reduced. Therefore, a user can then rotate one of the knobs 408 more easily. A sensor (not shown in FIG. 4) detects the position of the rotation. A microcontroller (not shown in FIG. 4) can then adjust voltage/current applied to the piezoelectric material to modify the friction felt by users as they rotate knobs 408, and thereby produce various types of haptic feedback based on the position, speed, or acceleration of the knobs 408. For example, the control panel 404 may be an automotive control panel and the knobs 408 may be a temperature control knob. In such an embodiment, rotating knob 408 one rotational degree may correspond to one degree of temperature adjustment. The knob 408 may provide haptic feedback to the user each time the temperature is adjusted by one degree (i.e., at each degree of rotation, a resistance force is provided to alert the user that the temperature has been adjusted by one degree). This is advantageous because a user can accurately adjust the temperature of the automobile without looking at the displayed temperature, allowing the user to keep his or her eyes on the road.

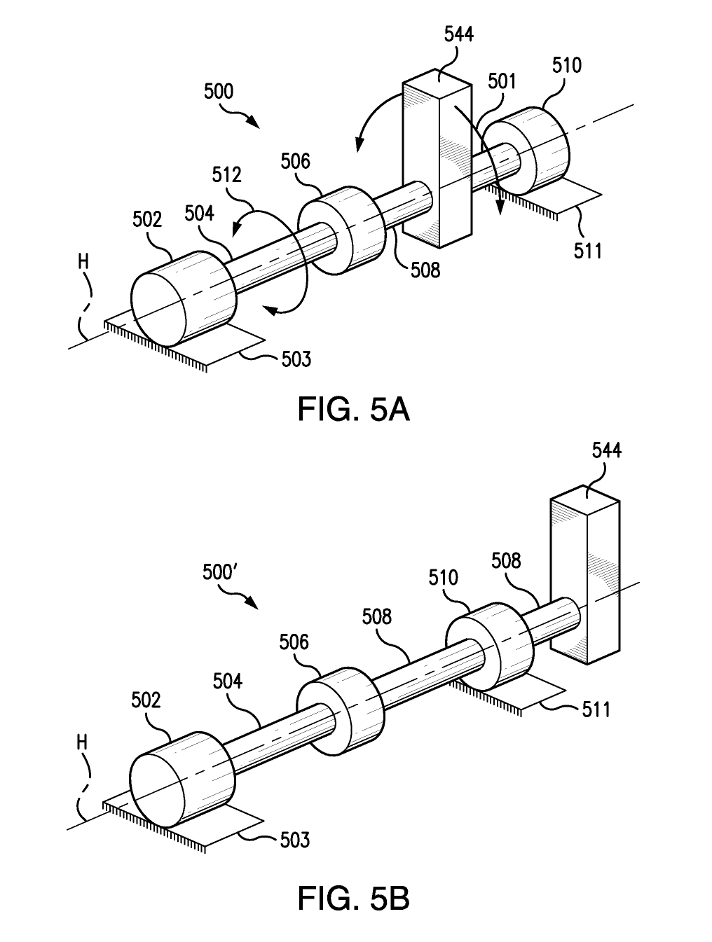

The passive actuator described herein may be provided in other haptic feedback systems. These haptic feedback systems may have one or more degrees of freedom. Some examples of embodiments of the present invention are described with reference to FIGS. 5A, 5B, 6, 7, 8 and 9. These systems are provided merely for illustration of embodiments of applications of the passive actuator, and are not intended to be limiting.

FIG. 5A is a schematic diagram of a transducer system 500 that includes a passive actuator according to one embodiment of the present invention. As shown in FIG. 5A, the transducer system 500 is applied to a mechanism having one degree of freedom, as shown by arrows 501. Embodiments in which system 500 is applied to systems having additional degrees of freedom are described below. The transducer system 500 includes an actuator 502, an actuator shaft 504, a non-rigidly attached coupling 506, a coupling shaft 508, a sensor 510, and an object 544.

In the embodiment shown in FIG. 5A, the actuator 502 is affixed to ground at 503. The actuator 502 is rigidly coupled to an actuator shaft 504 which extends from the actuator 502 to the non-rigidly attached coupling 506. When powered, the actuator 502 provides rotational forces, shown by arrows 512, on the actuator shaft 504, and thereby applies force to object 544. In one embodiment, the actuator 502 is the passive actuator which is configured to apply a resistive or frictional force (i.e., drag) to the shaft 504 in the directions of arrow 512 but cannot provide an active force to the shaft 504 (i.e., the actuator 502 cannot cause the shaft 504 to rotate). Thus, an external rotational force, such as a force generated by a user, is applied to the shaft 504, and the passive actuator 502 provides resistive forces to that external rotational force. The passive actuator imposes a resistance to the motion of the object 544 when a user manipulates object 544. Thus, a user who manipulates an interface having passive actuators feels forces only when the user actually moves object 544.

The actuator 502 comprises a piezoelectric material, which when driven by an ultrasonic haptic signal received from a microcontroller (not shown in FIG. 5A) reduces the friction on actuator 502. Thus, a microcontroller may reduce the resistance that a user feels when manipulating the object 544. This may generate various effects, for example, notch effects, hill effects, hard stops, or some other rotary haptic effect.

The coupling 506 is coupled to the actuator shaft 504. The actuator 502, actuator shaft 504, and coupling 506 can be considered to be an “actuator assembly” or, in a passive actuator system, a “braking mechanism.” In one embodiment, the coupling 506 is not rigidly coupled to the actuator shaft 504 so that there is an amount (magnitude) of “play” between the actuator shaft 504 and the coupling 506. The term “play”, as used herein, refers to an amount of free movement or “looseness” between a transducer and the object 544, so that, in some embodiments, the object 544 can be moved a short distance by externally-applied forces without being affected by forces applied to the object 544 by actuator 502. In one embodiment, the user can move the object a short distance without fighting the drag induced by a passive actuator 502. For example, the actuator 502 can apply a resistive or frictional force to the actuator shaft 504 so that the actuator shaft 504 is locked in place even when force is applied to the shaft. The coupling 506, however, can still be freely rotated by an additional distance in either rotational direction due to the play between the coupling 506 and shaft 504. This play is intentional for purposes that will be described below, and is thus referred to as a “desired” amount of play. Once the coupling 506 is rotated to the limit of the allowed play, it either forces the shaft 504 to rotate with it further; or, if the actuator 502 is holding (i.e., locking) the shaft 504, the coupling cannot be further rotated in that rotational direction. The amount of desired play between the actuator 502 and the object 544 greatly depends on the resolution of the sensor 510, and is described in greater detail below. Examples of types of play include rotary backlash, such as occurs in gear systems, and compliance or torsion flex, which can occur with flexible, rotational and non-rotational members.

The coupling shaft 508 is rigidly coupled to the coupling 506 and extends to the sensor 510. In one embodiment, the sensor 510 is rigidly coupled to the coupling shaft 508 to detect rotational movement of the shaft 508 and object 544 about axis H. The sensor 510 provides an electrical signal indicating the rotational position of the shaft 508 and is affixed to a ground point 511. In one embodiment, the sensor 510 is a digital optical encoder. In other embodiments, the sensor 510 may be separated from the object 544, coupling shaft 508, and coupling 506. For example, a sensor having an emitter and detector of electromagnetic energy may be disconnected from the rest of transducer system 500 yet be able to detect the rotational position of the object 544 using a beam of electromagnetic energy, such as infrared light. Similarly, a magnetic sensor detects the position of the object 544 while uncoupled from the shaft 508 and object 544.

The object 544 is rigidly coupled to the coupling shaft 508. The object 544 can take a variety of forms and can be directly coupled to the coupling shaft 508 or can be coupled through other intermediate members to the shaft 508. In FIG. 5A, the object 544 is coupled to the shaft 508 between the coupling 506 and sensor 510. Thus, as the object 544 is rotated about axis H, the shaft 508 is also rotated about axis H and the sensor 510 detects the magnitude and direction of the rotation of object 544. Alternatively, the object 544 can be coupled directly to the coupling 506. The coupling 506 and/or shafts 504 and 508 can be considered a “play mechanism” for providing the desired play between the actuator 502 and the object 544. Certain suitable objects 544 include a joystick, medical instrument (for example, a catheter or laparoscope), a steering wheel (e.g., having one degree of freedom), or a pool cue.

The use of a passive actuator comprising a piezoelectric material, as described above, includes several advantages. For example, a passive actuator comprising a piezoelectric material to reduce friction is controllable. Thus, multiple different effects may be output by the same device. Further, the piezoelectric material may require less power than an active actuator. Additionally, since the passive actuator can only restrict motion, the haptic effect will not cause the object to move against the user.

FIG. 5B illustrates a transducer system 500′ that is similar to the transducer system 500 shown in FIG. 5A. In this embodiment, the sensor 510 is positioned between the coupling 506 and the object 544 on the coupling shaft 508. The coupling shaft 508 extends through the sensor 510 and can be rigidly coupled to the object 544 at the end of the shaft. The transducer system 500′ functions substantially the same as the transducer system 500.

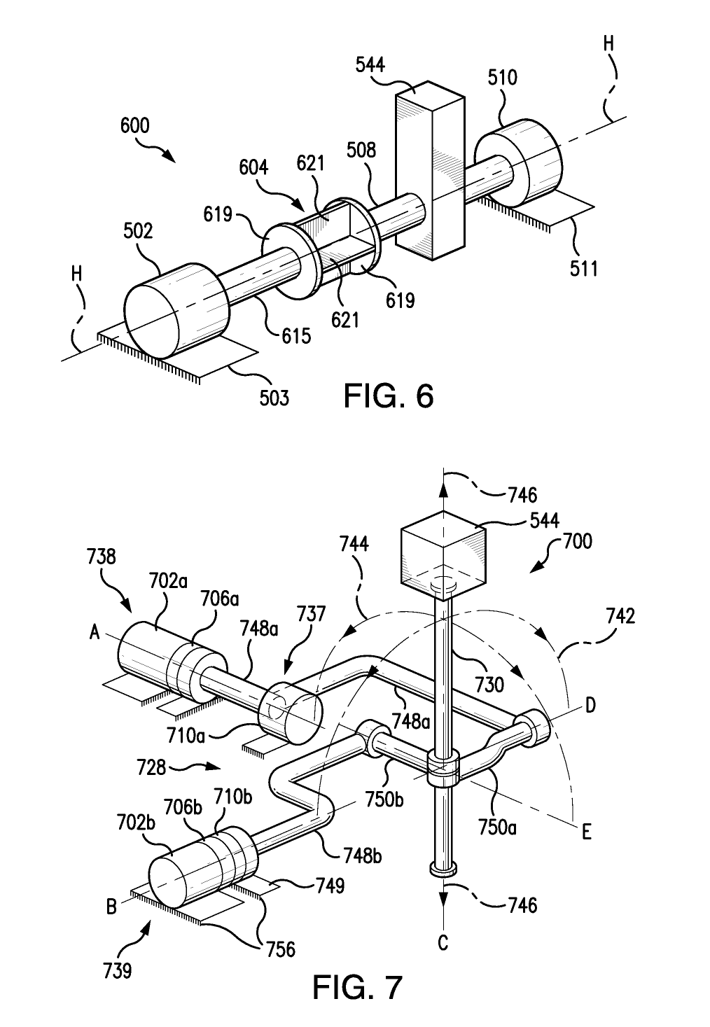

FIG. 6 illustrates a transducer system 600 that includes a flexible (i.e., compliant) coupling 604 between the actuator 502 and the object 544. The flexible coupling can take many possible forms, as is well known to those skilled in the art. The flexible coupling 604 allows the coupling shaft 508 to rotate independently of the actuator shaft 504 for a small distance, and then forces the actuator shaft 504 to rotate in the same direction as the coupling shaft 508. The flexible coupling 604 has two ends 619 and lengthwise portions 621 that provide torsion flex between the ends 619. The flexible coupling 604 thus allows an amount of torsion flex about the axis H between the coupling shaft 508 and the actuator shaft 615. When the actuator shaft 615 is locked in place by the actuator 502, the coupling shaft 508 is rotated, and the coupling 604 is flexed to its limit in one rotational direction, the shaft 508 is prevented from rotating in the same direction and the user is prevented from moving the object 544 further in that direction. If the object 544 and the coupling shaft 508 are caused to suddenly rotate in the opposite direction, the coupling 604 flexes freely in that direction and this movement is detected by sensor 510, allowing a microcontroller to apply a haptic signal to a piezoelectric material, and thereby change the resistive force applied by the actuator 502 accordingly. When the coupling 604 reaches its maximum flexibility in the other direction, the mechanism performs similarly and the user feel forces (if any) from the actuator 502. Compliance or flex can also be provided by, for example, spring members. As in the embodiments described above, actuator 502 comprises a piezoelectric material, which when driven at an ultrasonic frequency reduces the friction in actuator 502 to output rotary effects, such as detents, hills, or hard stops.

FIG. 7 is a schematic diagram of an embodiment of a mechanical apparatus 700 using the transducer system 500. The apparatus 700 includes a gimbal mechanism 728 and a linear axis member 730. The user object 544 is coupled to the linear axis member 730. The gimbal mechanism 728 provides two revolute degrees of freedom as shown by arrows 742 and 744. The linear axis member 730 provides a third linear degree of freedom as shown by arrows 746. Coupled to each extension member 748a and 748b is a transducer system 738 (equivalent to transducer system 500) and 739 (equivalent to transducer system 500′), respectively.

The transducer system 700 is similar to the system shown in FIG. 5A in which the object 544 is positioned between the coupling 506 and the sensor 510. The transducer system 700 includes an actuator 702a, which is grounded and coupled to a coupling 706a (ground 756 is schematically shown coupled to ground member 746). The coupling 706a is coupled to extension member 748a which ultimately connects to object 544 and provides a revolute degree of freedom about axis A. The sensor 710a is rigidly connected to the extension member 748a at the first bend 737 in the extension member. The sensor 710a is also grounded by either coupling it to the ground member 749 or separately to the ground 756. The sensor 710a thus detects all rotational movement of extension member 748a and object 744 about axis A. In some embodiments, sensor 710a can also be rigidly coupled to the extension member 748a at other positions or bends in member 748a, or even on central member 750b, as long as the rotation of the object 544 about axis A is detected.

The transducer system 739 is similar to the transducer system shown in FIG. 5B in which sensor 510 is positioned between the coupling 506 and the object 544. An actuator 720b is grounded and is non-rigidly coupled (i.e., coupled with the desired play as described above) to a coupling 706b. The coupling 706b is rigidly coupled, in turn, to a sensor 710b, which separately grounded and rigidly coupled to the ground member 746 (leaving coupling 706b ungrounded). The extension member 748b is also rigidly coupled to the coupling 706b by a shaft extending through the sensor 710b (not shown). The sensor 710b thus detects rotational movement of the extension member 748b and the object 744 about axis B.

Rotational resistance or impedance can thus be applied to either or both of the extension members 748a and 748b and the object 544 using actuators 702a and 702b. The couplings 706a and 706b allow a computer to sense the movement of the object 544 about either axis A or B when actuators are locking the movement of the object 544. A similar transducer system to system 738 or 739 can also be provided for the linear axis member 740 to sense movement in and provide force feedback to a third degree of freedom along axis C.

Use of passive actuators comprising a piezoelectric material as described above in the device shown in mechanical apparatus 700 includes several advantages. For example, a passive actuator comprising a piezoelectric material to reduce friction is controllable. Thus, the resistance the user feels when moving object 544 can be adjusted. This may be used to, for example, adjust the resistance based on the speed, direction, or acceleration of the user's movement. Further, the piezoelectric material may require less power than an active actuator in a similar application. Additionally, since the passive actuator can only restrict motion, the haptic effect will not cause the object 544 to move against the user.

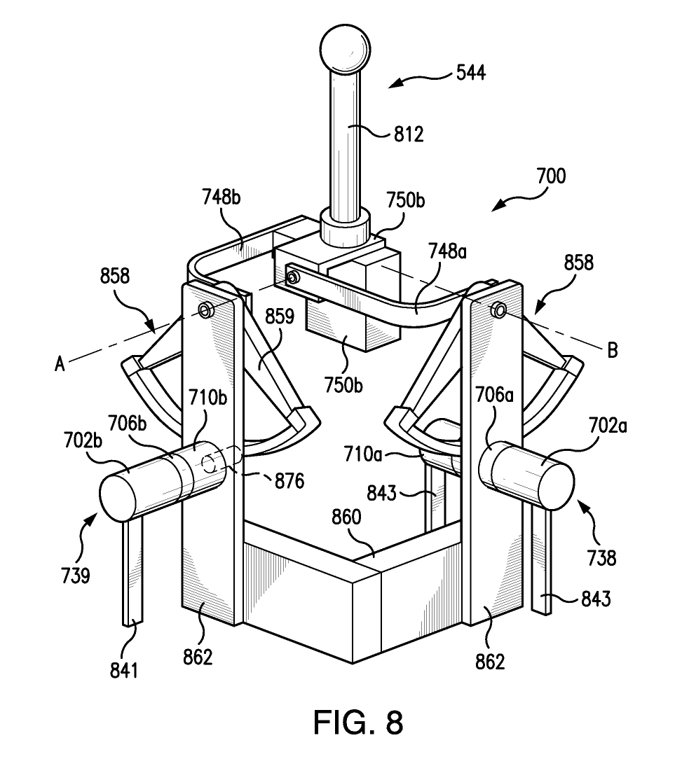

FIG. 8 is a perspective view of an embodiment of the mechanical apparatus 700 shown in FIG. 7. The object 544 in FIG. 8 is implemented as a joystick 812 movable in two degrees of freedom about axes A and B. For illustrative purposes, apparatus 700 is shown with two embodiments of transducer system 500 and 500′. The system 739 is shown similarly as in FIG. 7 and includes the actuator 702b, coupling 706b, and sensor 710b, with the appropriate shafts connecting these components. The sensor 710b is also coupled to a vertical support 862. The actuator 702b is grounded by, for example, a support member 841. The coupling shaft 708 extending from the sensor 710b is preferably coupled to a capstan pulley 876 of a capstan drive mechanism 858. When the object 544 is moved about the axis A, the extension member 748b is also moved, which causes the capstan member 859 (which is rigidly attached to member 748b) to rotate. This movement causes the pulley 876 to rotate and thus transmits the motion to the transducer system 739. The capstan mechanism allows movement of the object 544 without substantial backlash. This allows the introduced, controlled backlash of the coupling 706 to be the only backlash in the system. The sensor 710b can thus detect rotation at a higher resolution and the actuator 702b can provide greater forces to the object 544. This can be useful when, for example, a user can overpower the resistive forces output by the actuator 702b; the capstan mechanism 858 allows greater forces to be output from an actuator that are more difficult for the user to overcome. A different type of gearing system can also be used to provide such mechanical advantage, such as a pulley system. The transducer system 739 or 738 can also be directly connected to ground member 746 and extension member 748a or 748b, as shown in FIG. 7. For example, the transducer system 739 can be directly coupled to the vertical support 862 and capstan member 859 on axis A. As described above, actuators 702a and 702b comprise passive actuators, the range of available effects is further enhanced by the addition of a piezoelectric material to reduce friction. Further, as described above, the piezoelectric material can have advantages in reducing the power consumed by the system as well.

The transducer system 738 is shown coupled to the other extension member 748a similarly as in FIG. 7. In this configuration, the actuator 702a and the coupling 706a are positioned on one side of the vertical support member 862, which is coupled to the other vertical support member through a coupling 860. The coupling shaft 708 preferably extends through the vertical support member 862 and pulley 876 and is coupled to the sensor 710a, which is grounded. Alternatively, sensor 710b can be coupled to the capstan member and vertical support 862 at axis B. The actuator 702a and the sensor 710b may be grounded by, for example, the support members 843.

The transducer systems 738 and 739 can also be used with other apparatuses. For example, a third linear degree of freedom and a fourth rotational degree of freedom can be added. The transducer systems 738 or 739 can be used to sense movement in and provide force feedback to those third and fourth degrees of freedom. Similarly, the transducer systems 738 or 739 can be applied to the fifth and sixth degrees of freedom.

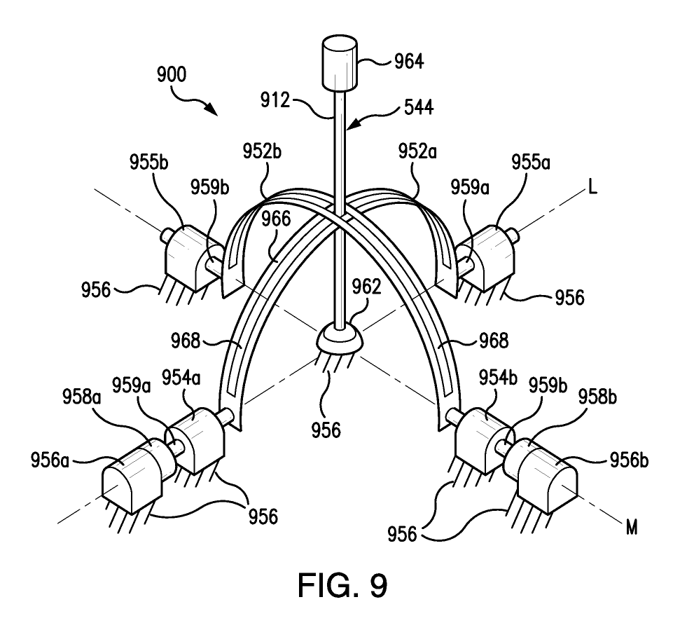

FIG. 9 is a perspective view of an alternate interface apparatus 900 suitable for use with the transducer system 500. The apparatus 900 includes a slotted yoke configuration for use with joystick controllers that is well-known to those skilled in the art. The apparatus 900 includes a slotted yoke 952a, slotted yoke 952b, sensors 954a and 954b, bearings 955a, and 955b, actuators 956a and 956b, couplings 958a and 958b, and joystick 944. The slotted yoke 952a is rigidly coupled to the shaft 959a that extends through and is rigidly coupled to the sensor 954a at one end of the yoke. Slotted yoke 952a is similarly coupled to shaft 959c and bearing 955a at the other end of the yoke. Slotted yoke 952a is rotatable about axis L and this movement is detected by sensor 954a. Coupling 954a is rigidly coupled to shaft 959a and is coupled to actuator 956. In other embodiments, the actuator 956a and the coupling 958a are instead coupled to the shaft 959c after the bearing 955a. In yet other embodiments, the bearing 955a and be implemented as another sensor like sensor 954a. As in the embodiments described above, actuators 956a and 956b each comprise a piezoelectric material, which when actuated, reduces the resistive force output by actuators 596a and 956b. This reduction in force can be used to output various resistive effects, which the user feels when manipulating an object connected to end 964.

Similarly, the slotted yoke 952b is rigidly coupled to the shaft 959b and the sensor 954b at one end and shaft 959d and bearing 955b at the other end. The yoke 952b can be rotated about the axis M, and sensor 54b will then detect this movement. A coupling 958b is rigidly coupled to the shaft 959b and an actuator 956b is coupled to the coupling 958b such that a desired amount of play is allowed between the shaft 959b and the actuator 956b.

In the illustrated embodiment, the object 544 is a joystick 912 that is pivotally attached to the ground surface 960 at one end 962 so that the other end 964 typically can move in four 90-degree directions above the surface 960 (and additional directions in other embodiments). The joystick extends through the slots 966 and 968 in yokes 952a and 952b, respectively. Thus, as the joystick is moved in any direction, the yokes 952a and 952b follow the joystick and rotate about the axes L and M. The sensors 954a-d detect this rotation and can thus track the motion of the joystick. The addition of the actuators 956a and 956b allows the user to experience force feedback when handling the joystick. The couplings 958a and 958b provide an amount of play to allow a controlling system to detect a change in the direction of the joystick, even if the joystick is held in place by the actuators 956a and 956b. In other embodiments, other types of objects 544 can be used in place of a joystick, or additional objects can be coupled to the joystick.

In alternate embodiments, the actuators and couplings can be coupled to shafts 959c and 959d to provide additional force to the joystick. The actuator 956a and an actuator coupled to the shaft 959c can be controlled simultaneously by a computer or other electrical system to apply or release force from the bail 952a. Similarly, the actuator 956b and an actuator coupled to the shaft 959d can be controlled simultaneously.

Use of passive actuators comprising a piezoelectric material as described above in the device shown in interface apparatus 900 includes several advantages. For example, a passive actuator comprising a piezoelectric material to reduce friction is controllable. Thus, the resistance the user feels when moving object 964 can be adjusted. This may be used to, for example, adjust the resistance based on the speed, direction, or acceleration of the user's movement. Further, the piezoelectric material may require less power, and have a lower purchase price, than an active actuator in a similar application. Additionally, since the passive actuator can only restrict motion, the haptic effect will not cause the object 964 to move against the user.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

### GENERAL CONSIDERATIONS

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, a haptic effect selection routine, and suitable programming to produce signals to generate the selected haptic effects as noted above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A haptic device comprising:
a passive actuator comprising:
a rotatable plate;
a fixed plate configured to apply friction to the rotatable plate;
a piezoelectric material mounted to one of the fixed plate or the rotatable plate, the piezoelectric material configured to receive a first haptic signal and vibrate; and
a rotatable object configured to be connected to the rotatable plate.

2. The passive actuator of claim 1, wherein the first haptic signal is an ultrasonic signal.

3. The passive actuator of claim 1, wherein the vibration is configured to reduce the friction applied to the rotatable plate.

4. The passive actuator of claim 1, wherein the piezoelectric material is a piezoceramic plate.

5. The passive actuator of claim 1, wherein the piezoelectric material is mounted between the fixed plate and the rotatable plate.

6. The passive actuator of claim 1, wherein the rotatable object is mounted to the rotatable plate.

7. The passive actuator of claim 1, wherein the rotatable object comprises a knob.

8. The passive actuator of claim 1, wherein the rotatable plate is mounted to define a gap between the rotatable plate and the fixed plate.

9. The haptic device of claim 1, further comprising a coupling between the rotatable plate and the rotatable object.

10. The passive actuator of claim 9, wherein the coupling comprises a flexible coupling.

11. The haptic device of claim 1, further comprising a microcontroller.

12. The haptic device of claim 11, wherein the microcontroller is configured to adjust a characteristic of the first haptic signal.

13. The haptic device of claim 11, wherein the microcontroller is configured to transmit a second haptic signal to an active actuator configured to output a second haptic effect.

14. The haptic device of claim 13, wherein the active actuator comprises one of: a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

15. The haptic device of claim 11, further comprising a sensor configured to detect motion of the rotatable object and transmit a sensor signal to the microcontroller.

16. The haptic device of claim 15, wherein the microcontroller is configured to adjust a characteristic of the first haptic signal based at least in part on the sensor signal.

17. The haptic device of claim 15, wherein the sensor is an optical encoder.

18. The haptic device of claim 11, further comprising a voltage source configured to be controlled by the microcontroller to modify a characteristic of the first haptic signal.

19. A method comprising:
transmitting a first haptic signal to a piezoelectric material configured to receive the first haptic signal and vibrate, the piezoelectric material mounted to one of a rotatable plate or a fixed plate, the fixed plate configured to apply friction to the rotatable plate.

20. The method of claim 19, further comprising receiving a sensor signal indicating movement of a rotatable object connected to the rotatable plate, the rotatable object mounted such that the rotatable object and the rotatable plate rotate together.

21. The method of claim 20, further comprising adjusting a characteristic of the first haptic signal based at least in part on the sensor signal.

22. The method of claim 20, further comprising transmitting a second haptic signal correspondence to a second haptic effect to an active actuator configured to output the second haptic effect.

23. The method of claim 20, wherein the second haptic signal is determined based at least in part on a second sensor signal indicating movement of the rotatable object.

24. The method of claim 19, wherein transmitting the first haptic signal comprises determining a rotary haptic effect.

25. The system of claim 20, wherein the rotary haptic effect comprises one of: a detent, a hill, a barrier, a hard stop, or a continuous force.

26. A haptic feedback system comprising:
a passive actuator comprising:
a rotatable plate;
a fixed plate configured to apply friction to the rotatable plate;
a piezoelectric material mounted to the fixed plate and configured to receive an ultrasonic haptic signal and vibrate, the vibration configured to modify the friction between the fixed plate and the rotatable plate; and
a rotatable knob connected to the rotatable plate, such that the rotatable knob and rotatable plate rotate together;
a microcontroller configured to receive a sensor signal from a sensor configured to detect motion of the rotatable knob, the microcontroller further configured to adjust a characteristic of the ultrasonic haptic signal based at least in part on the sensor signal; and
a display configured to display a user interface comprising setting which can be adjusted by manipulating the rotatable knob.
